(19) United States
(12) Patent Application Publication
(10) Pub. No.: US 2010/0289660 A1
(43) Pub. Date: Nov. 18, 2010

(54) MOTOR VEHICLE HAVING AN ENVIRONMENTAL SENSOR AND METHOD FOR OPERATING THE ENVIRONMENTAL SENSOR

(75) Inventor: Uwe BONNE, Kriftel (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/774,622

(22) Filed: May 5, 2010

(30) Foreign Application Priority Data
May 14, 2009 (DE) 102009021284.1

(51) Int. Cl. G08B 21/00

(52) U.S. Cl. 340/670

(57) ABSTRACT

A motor vehicle is equipped with an environmental sensor, which emits signals and receives reflected signals. In order to reduce influences on the environment, a transmission power of the environmental sensor can be regulated as a function of velocity. Furthermore, a corresponding method for activating the environmental sensor is disclosed.

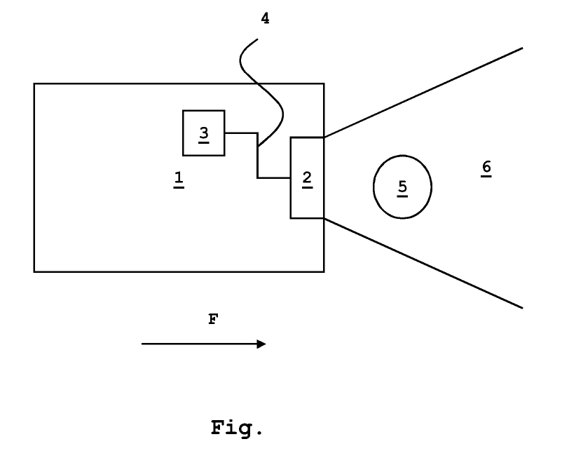

### CROSS-REFERENCE TO RELATED APPLICATION

This application claims priority to German Patent Application No. 102009021284.1, filed May 14, 2009, which is incorporated herein by reference in its entirety.

### TECHNICAL FIELD

The invention relates to a motor vehicle having an environmental sensor, which emits signals and receives reflected signals, and to a method for operating the environmental sensor.

### BACKGROUND

Modern motor vehicles are equipped with various environmental sensors, in order to, inter alia, monitor a vehicle environment during a parking procedure for the presence of stationary or mobile obstructions. If the approach to a building wall is established by such a parking assistance sensor, for example, visual and/or acoustic warning signals are output in order to avoid running into the obstruction.

Furthermore, distance sensors are known, using which a distance to another traffic participant driving ahead can be monitored. If the distance falls below a velocity-dependent minimum distance, a visual and/or acoustic warning signal is also output in order to inform the driver of this potential traffic-hazard situation.

A method and a device for the detection and identification of objects having a small vertical dimension is known from DE 10 2006 020 387 B4. Electromagnetic radiation is emitted in the travel direction in front of the vehicle and the beams reflected from an object are received. If the presence of an object is detected, a driving assistance system can be influenced accordingly, in order to minimize a hazard potential, for example. In particular, objects of small vertical extension can be more or less blanked out, because no danger to traffic safety originates there from.

The known environmental sensors are disadvantageous in that they are activated at a predefined transmission power, in order to be able to receive the strongest possible reflected signal strength. The influence of electromagnetic radiation, in particular high-frequency radar radiation, on the human body is to be classified at least as critical.

In view of the foregoing, it is at least one object to provide a motor vehicle of the type cited at the beginning from which the least possible hazard potential originates, in particular to persons. Furthermore, a corresponding method for activating an environmental sensor is to be disclosed. In addition, other objects, desirable features, and characteristics will become apparent from the subsequent summary and detailed description, and the appended claims, taken in conjunction with the accompanying drawings and this background.

### SUMMARY

The at least one object, other objects, desirable features, and characteristics, are achieved in the case of a motor vehicle in that a transmission power of the ambient sensor can be regulated as a function of velocity, and in the case of the method in that a transmission power of the environmental sensor is regulated as a function of velocity.

In the case of a motor vehicle implemented in this manner, an environmental sensor known per se is installed, which provides signals for a parking assistance system or for a distance warning or collision avoidance system, for example, the environmental sensor being designed in such a manner, however, that it can be regulated in its transmission power, i.e., it can either be operated at maximum transmission power or at lower transmission powers down to complete deactivation.

The environmental sensor is activated in such a manner that it is operated at a low transmission power when stationary or at only a low vehicle velocity. For this purpose, one skilled in the art can select the transmission power as a function of velocity, so that the transmitting and receiving range is at least as large as the velocity-dependent braking distance. As soon as an object or an obstruction is established within a correspondingly small receiving range when driving slowly, a braking maneuver can still be initiated in a timely manner. At higher vehicle velocities, the transmission power is increasingly elevated and, for example, above a velocity of approximately 100 km/h, the environmental sensor is operated at full transmission power, in order to ensure a maximum receiving range. Vehicle velocities of this type are typically only achieved on multilane freeways or well-built state roads, on which no pedestrians or persons are typically located, who accordingly also could not be acquired by the signals emitted by the environmental sensor. At slow vehicle velocities or when stationary, for example, during an inner-city traffic jam at a traffic light, in contrast, it is entirely possible that a pedestrian will pass in front of or behind the motor vehicle and will be practically uninfluenced by the signals of the environmental sensor, which are only emitted at low strength. Such an environmental sensor will also only be operated at low transmission power in the stationary state of the motor vehicle in the workshop, during which the ignition is turned on for test purposes, for example, in order not to harm the workshop personnel.

The velocity-dependent control of the environmental sensor can either be performed by reducing the transmission power or the environmental transmitter is operated in pulsed operation at longer or shorter intervals, in order to reduce the average transmission power.

At least one advantage is that only components already present in the motor vehicle must be used and only the environmental sensor must be slightly modified in order to operate it at varying transmission power. A velocity-dependent controller can be implemented without significant effort in a central control unit of the motor vehicle. In addition, a reduction of the quantity of data to be processed of the received reflected signals can also be achieved by a reduction of the transmission power. For example, in inner-city traffic at slow vehicle velocity, interfering reception influences, in particular from traffic islands which are far ahead, may be suppressed by a restricted receiving range.

All sensors known to one skilled in the art, i.e., sensors having various measuring principles, such as infrared or ultrasound sensors, may be used as the sensors. However, radar or laser (lidar) sensors are preferably activated appropriately. High-frequency radar radiation can damage human tissue if a limiting value for the transmission power is exceeded. Accordingly, in particular in inner-city traffic, the transmission power is reduced. Preferably there is a reduction of the laser power at low vehicle velocities.

The transmission power is expediently changeable, in particular the transmission power is maximized, in the case of automatic recognition of a hazard situation or a potential traffic-hazard situation. Such a hazardous situation can be automatically established by the recognition of driving too close and/or by abrupt actuation of a brake pedal, for example.

In contrast, if the motor vehicle travels at an essentially constant distance to another traffic participant driving ahead over a longer period of time, for example, when driving in a column on a freeway, the transmission power can be regulated down in such a manner that this traffic participant driving ahead is still just in the acquisition range of the environmental sensor. If the distance becomes smaller, this can be established as previously. However, if the distance becomes greater, i.e., the other traffic participant leaves the acquisition range, the transmission power can be increased automatically.

Preferably, in the event of an approach of the motor vehicle to an intersection and/or a junction and/or a blind spot in the course of the road, such as a hilltop or the like, the transmission power is automatically increased, even if this does not correspond to a possibly slowed vehicle velocity. In this way, other motor vehicles approaching laterally and possibly located far ahead may also be detected and a collision may thus be avoided. The automatic recognition of the approach to the intersection can be performed using the position data provided from a navigation system or with the aid of an image acquisition system and an image processing system.

The above-mentioned features and the features to be explained hereafter are usable not only in the particular specified combination, but rather also in other combinations.

### BRIEF DESCRIPTION OF THE DRAWINGS

The present invention will hereinafter be described in conjunction with the following drawing FIGURE showing a motor vehicle according to an embodiment of the invention in a schematic top view.

### DETAILED DESCRIPTION

The following detailed description is merely exemplary in nature and is not intended to limit application and uses. Furthermore, there is no intention to be bound by any theory presented in the preceding background or summary or the following detailed description.

The motor vehicle 1 travels forward in the travel direction F and has an environmental sensor 2, which illuminates an environment in front of the motor vehicle 1 using electromagnetic radar signals or using an optical laser, for example, in order to establish the presence of stationary or mobile obstructions in an acquisition range 6. For example, if it is established that the distance to another traffic participant traveling ahead has fallen below a safety distance as a function of velocity, corresponding warning signals are visually and/or acoustically output.

Furthermore, the motor vehicle 1 has a control unit 3 for controlling all functions, the individual components of the motor vehicle 1 being connected to one another via connections 4, such as data bus lines.

The transmission power of the environmental sensor 2 is regulated as a function of velocity. This means that at low vehicle velocities or when stationary, the transmission power of the environmental sensor 2 is minimal and the acquisition range 6 is correspondingly reduced. At higher vehicle velocities, the acquisition range 6 is enlarged more and more by elevating the transmission power and, for example, the environmental sensor 2 is operated at maximum power from a vehicle velocity of approximately 100 km/h, in order to allow a receiving range up to approximately 200 m. The environmental sensor 2 can also be operated in a pulsed manner using variable cycle times in order to vary the transmission power as a whole.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A motor vehicle, comprising:
a detector adapted to detect a velocity of the motor vehicle; and
an environmental sensor that is adapted to emit a signal and receive a reflective signal; and
a regulator adapted to regulate a transmission power of the environmental sensor as a function of the velocity.

2. The motor vehicle according to claim 1, wherein the environmental sensor is a radar sensor.

3. The motor vehicle according to claim 1, wherein the environmental sensor is a laser sensor.

4. The motor vehicle according to claim 1, wherein the transmission power of the environmental sensor is adjustable based upon an establishment of a hazard situation.

5. The motor vehicle according to claim 1, wherein the transmission power of the environmental sensor is adjustable upon an establishment of an essentially constant distance to another traffic participant.

6. The motor vehicle according to claim 1, wherein upon establishment of an approach to an intersection, the transmission power of the environmental sensor is adjustable.

7. The motor vehicle according to claim 1, wherein upon establishment of an approach to an opening of a roadway, the transmission power of the environmental sensor is adjustable.

8. The motor vehicle according to claim 1, wherein upon establishment of an approach to a blind spot in a roadway, the transmission power of the environmental sensor is adjustable.

9. A method for operating an environmental sensor in a motor vehicle, comprising the steps of:
detecting with a detector a velocity of the motor vehicle; and
regulating a transmission power of the environmental sensor with a regulator as a function of the velocity.

10. The method according to claim 9, wherein the environmental sensor is a radar sensor

11. The method according to claim 9, wherein the environmental sensor is a laser sensor.

12. The method according to claim 9, further comprising the step of changing the transmission power of the environmental sensor upon establishment of a hazard situation.

13. The method according to claim 9, further comprising the step of changing the transmission power of the environmental sensor upon establishment of an essentially constant distance to another traffic participant.

14. The method according to claim 9, further comprising the step of changing the transmission power of the environmental sensor upon establishment of an approach to an intersection.

15. The method according to claim 9, further comprising the step of changing the transmission power of the environmental sensor upon establishment of an approach to a junction of a roadway.

16. The method according to claim 9, further comprising the step of changing the transmission power of the environmental sensor upon establishment of an approach to a blind spot of a roadway.
